(19) United States
(12) Patent Application Publication
(10) Pub. No.: US 2005/0047286 A1
(43) Pub. Date: Mar. 3, 2005

(54) Focus error signal generation

(76) Inventor: Darwin Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,004

(22) Filed: Aug. 29, 2003

(51) Int. Cl. G11B 7/00

(52) U.S. Cl. 369/44.23; 369/100

(57) ABSTRACT

A method of focus control is disclosed. In a passing action, a light source beam is passed over a reflectivity change on a storage media. In a determining action, a change time of a reflectivity step function is determined. In another determining action, a current light source spot size is determined using the change time and a storage media velocity.

### INTRODUCTION

Data, audio, and video information are increasingly stored on media such as compact discs (CD's) and digital versatile discs (DVD's). Various formats for storage of such data exist, such as CD-R, CD-RW, DVD-ROM, DVD+R, DVD-R, DVD+RW, and DVD-RW. Despite the differences in formats, however, storage devices which contain or are able to accept the various storage media often use a light source, such as a laser or high-power light-emitting diode, to read and/or write data on the storage media.

Data storage media such as CD's and DVD's contain several layers. For example, a substrate layer, often made of polycarbonate, is used to support a reflective layer. The reflective layer may have differences in reflectivity based on the properties of the layer itself (for example if the layer contains dyes which may be photo-activated). The reflective layer may also have differences in reflectivity which result from the conformation of the reflective layer to variations which have purposely been made in the substrate layer during a manufacturing process. Differences in reflectivity may also be caused by a combination of reflective layer properties and the topographical properties of the substrate where the substrate layer is coupled to the reflective layer. A protective layer, of acrylic for example, is often applied over the reflective layer. A label layer may be silk-screened or otherwise applied onto the protective layer.

Devices which may accept storage media, such as CD's or DVD's, often have an optical system which allows the light source to shine through the substrate side and onto the reflective data layer. The light then selectively or variably reflects back to a light sensor depending on the data state for each given data location on the surface of a storage medium. The size of a given data location is determined, in part, by the size of the light source spot which can be focused onto the storage medium. Many storage media readers and writers have a type of astigmatic focus error detection built into the optical path and control electronics in order to enable a suitable control over the focused spot size from the substrate side. As such, a spherical aberration is typically built into an objective focusing lens of the optical system to correct for the spherical aberration caused by the light passing through the medium substrate while performing a data reading and/or writing operation.

While the substrate side of a storage medium may be referred to as the data side of the medium or disc, it may also be desirable to read data from the label side of the disk, provided the label does not entirely block the light source. Unfortunately, while the astigmatic focusing process and system works well when reading or writing to media on the data side of the disc, it may encounter difficulties when trying to read or write data from the label side of the disc. Such difficulties arise due to lack of sufficient reflectivity of the disc and excessive surface roughness of the disc on the label side. This excessive roughness can cause scattering of light and distortion of the light wavefront arising from the fact that the spherical aberration correction built into the focusing lens is no longer cancelled by the spherical aberration arising from light traveling through the disc substrate as would be the case on the data side of the disc, or some combination thereof.

Despite difficulties focusing a light source from the label side of the disc, there is an increased interest in enabling existing optical architectures to focus a light source from the label side of a disc not only on the reflective data layer, but also or exclusively on the label surface itself. By enabling focus on the label layer, a light sensitive label material could be written to in such a way that custom labels on a disc could be imaged directly with the storage media light source. An example of a suitably light sensitive label material is disclosed in World Intellectual Property Application No. WO 03/032299 A2, entitled “Integrated CD/DVD Recording and Labeling”. Therefore, there exists a need for a suitable error focus generation technique which enables a label-side light source to focus on the storage media label and/or the storage media data layer without requiring a new optical path design.

### BRIEF DESCRIPTION OF THE DRAWINGS

FIG. 1 schematically illustrates one embodiment of a storage media drive optical path and control system for reading and/or writing data on storage media such as CD's and DVD's from the substrate side of the storage media.

FIG. 2 schematically illustrates one embodiment of a quadrature light sensor which may be used in an astigmatic focus scheme.

FIG. 3 schematically illustrates one embodiment of a storage media drive optical path and control system for reading and/or writing data on a storage media such as CD's and DVD's from the label side of the storage media.

FIG. 4 schematically illustrates one embodiment of writing a label on a storage media such as CD's and DVD's from the label side of the storage media using the embodiment of FIG. 3.

FIG. 5 schematically illustrates one embodiment of a storage media having one embodiment of a feature of reflectivity change.

FIGS. 6A-6E schematically illustrate embodiments of a feature of reflectivity change on a storage media passing nearby, under, and past a light source spot.

FIG. 7 illustrates one embodiment of a reflectivity step function.

FIG. 8 illustrates one embodiment of actions which may be taken to adjust the focus of a light source on a storage media.

FIGS. 9A-9C schematically illustrate embodiments of a slope detector for focus error signal generation.

### DETAILED DESCRIPTION OF THE PREFERRED EMBODIMENTS

Electronic devices are increasingly equipped with disc drives which can read and/or write data on storage media such as CD's and/or DVD's. These electronic devices may include, for example, desktop computers, notebooks, tablet computers, video and audio component equipment, televisions, video game stations, portable audio and video devices, external and internal storage devices, digital cameras, digital video cameras, digital photo equipment which produces or interfaces with a photo disc, and vending machines.

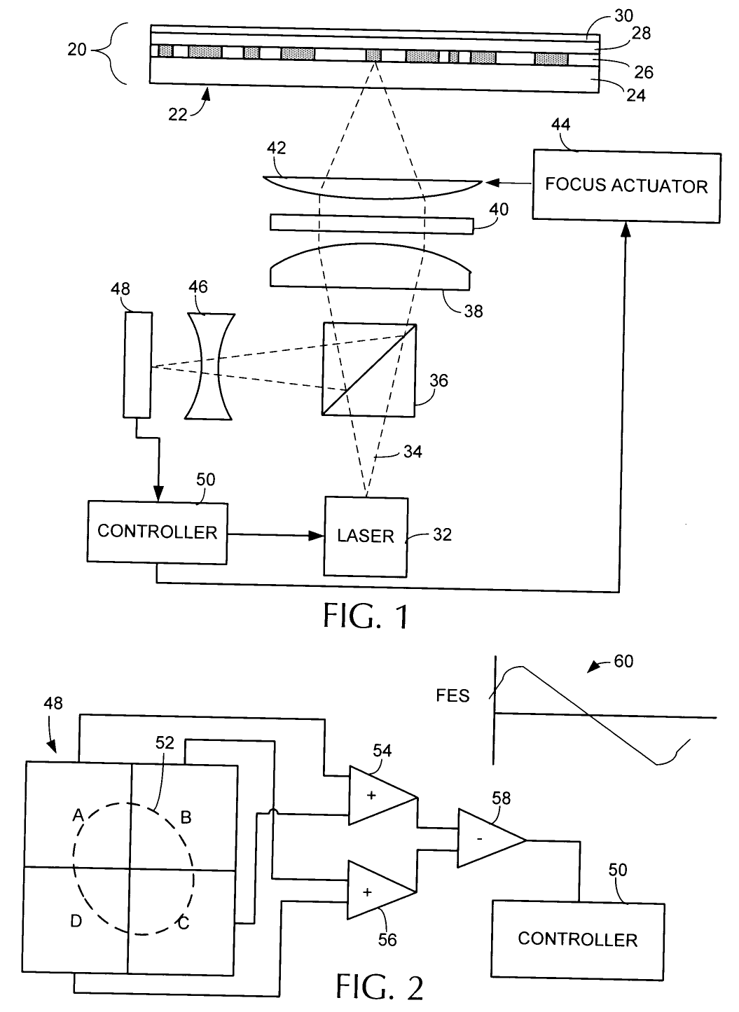

FIG. 1 schematically illustrates one embodiment of a storage media drive optical path and control system for reading and/or writing data on a storage media 20 such as a CD or a DVD from the substrate side 22 of the storage media 20. For the purpose of this disclosure, the term ‘media’ may refer to a single medium or media in the plural sense. The storage media may have a substrate layer 24, a reflective data layer 26, a protective layer 28, and a label layer 30. In order to read and/or write data on the storage media 20, a light source, such as laser 32 is focused onto the data layer 26 of the storage media 20. While a laser 32 is used in the embodiment of FIG. 1, other embodiments may utilize alternative light sources, such as a high-power light emitting diode. The laser 32 may be grated to create one or more spots which can be focused onto the storage media 20. The embodiments described herein use one focused spot, however, it should be appreciated that gratings for multiple spots could also be used. The laser light 34 passes through a polarizing beam splitter 36 and into a collimator lens 38. The collimated light then makes a first pass through a quarter wave plate 40, which changes the phase of the laser light by ninety degrees. An objective lens 42 focuses the laser light onto the storage media 20. A focus actuator 44 is coupled to the objective lens 42, and is able to adjust the objective lens 42 towards and away from the storage media 20.

Depending on the reflectivity of the data layer 26, varying amounts of laser light 34 may reflect off of the data layer 26 and back through the objective lens 42 and to the quarter wave plate 40, where the phase of the reflected light is rotated an additional ninety degrees. This second pass through the quarter wave plate results in a reflected light passing backwards through the collimator lens 38 which is one-hundred eighty degrees out of phase with the original laser light 34. As a result, when this phase-shifted reflected light reaches the polarizing beam splitter 36, it is reflected through an astigmatic cylindrical lens 46 and onto a photo sensor 48. A controller 50 is coupled to the photo sensor 48, and allows light sensed at the photo sensor 48 to be analyzed. Analysis of the light can include determination of whether the light beam is properly focused and the light level being received at the photo sensor 48. The controller 50 may include analog circuitry, digital circuitry, an application specific integrated circuit (ASIC), a microprocessor, or any combination thereof. The controller 50 is coupled to the laser 32, and may control when the laser 32 is emitting light and at what intensity. The controller 50 is also coupled to the focus actuator 44, for the purpose of adjusting the position of the objective lens 42 to achieve a desired focus or spot size on the storage media 20. A focus error signal is typically generated by the photo sensor 48 and the controller 50 in order to drive the desired focus.

FIG. 2 schematically illustrates one embodiment of a quadrature photo sensor 48 which may be used in an astigmatic focus scheme. The photo sensor 48 may be divided into quarters, here illustrated as quadrant A, quadrant B, quadrant C, and quadrant D. Each quadrant has the ability to measure incident light independent of the others. The astigmatic cylindrical lens 46 from the optical path of FIG. 1 has different focal lengths in two perpendicularly intersecting planes. A spot projected through this cylindrical lens 46 will vary in shape from a tall ellipse, to a circle, to a wide ellipse, depending on the position of the objective lens 42 relative to the reflective data layer 26. FIG. 2, schematically illustrates an incident light spot 52 contacting the quadrants of the photo sensor 48. By summing 54 quadrants A and C, summing 56 quadrants B and D, and feeding the difference 58 to the controller 50, a focus error signal 60 may be observed. If the focus error signal 60 is positive, the objective lens 42 is too close, and the controller 50 may instruct the focus actuator 44 to pull the objective lens 42 back until the focus error signal 60 is substantially equal to zero. If the focus error signal 60 is negative, the objective lens 42 is too far, and the controller 50 may instruct the focus actuator 44 to push the objective lens 42 closer until the focus error signal 60 is substantially equal to zero. An astigmatic focus error detection scheme, such as the one illustrated in FIG. 2 works well when reading or writing data from the substrate side 22 of a storage media 20.

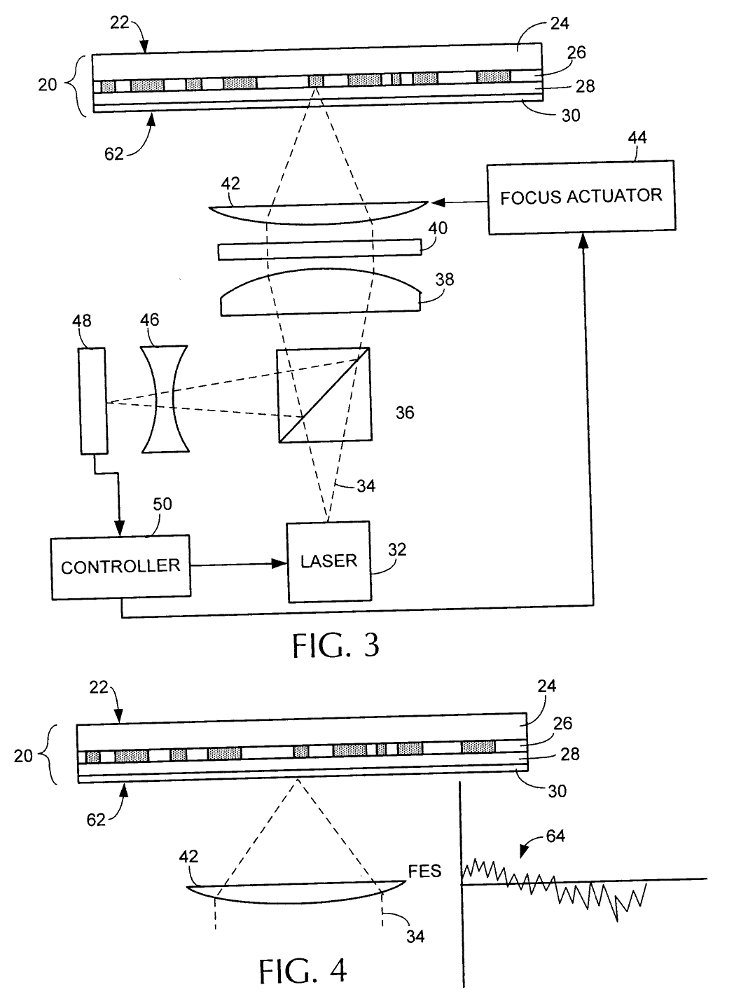

FIG. 3 schematically illustrates one embodiment of a storage media drive optical path and control system for reading and writing data on storage media such as CD's and DVD's from a label side 62 of the storage media 20. With the exception that the storage media 20 is flipped over, the optical path of the embodiment in FIG. 3 is identical to the optical path of the embodiment in FIG. 1. Laser light 34 may be focused onto the data layer 26, through the label layer 30 and the protective layer 28, and reflected back to the photo sensor 48.

As FIG. 4 illustrates, the laser light 34 may also be focused on the label layer 30. Unfortunately, one or more of several factors make the embodiments illustrated in FIGS. 3 and 4 difficult to focus, due to poor focus error signal generation. Such factors include a lack of sufficient reflectivity on the storage media 20 when approached from the label side 62 and excessive surface roughness on the label side 62. The surface roughness may cause scattering of light, distortion of the light wavefront arising from the fact that the spherical aberration correction built into the focusing lens 42 is no longer cancelled by the spherical aberration of the light passing through the substrate 24, or some combination thereof. In fact, the resultant focus error signal, when approaching the storage media 20 from the label side 62 may be extremely noisy, as illustrated by the noisy focus error signal 64 of FIG. 4.

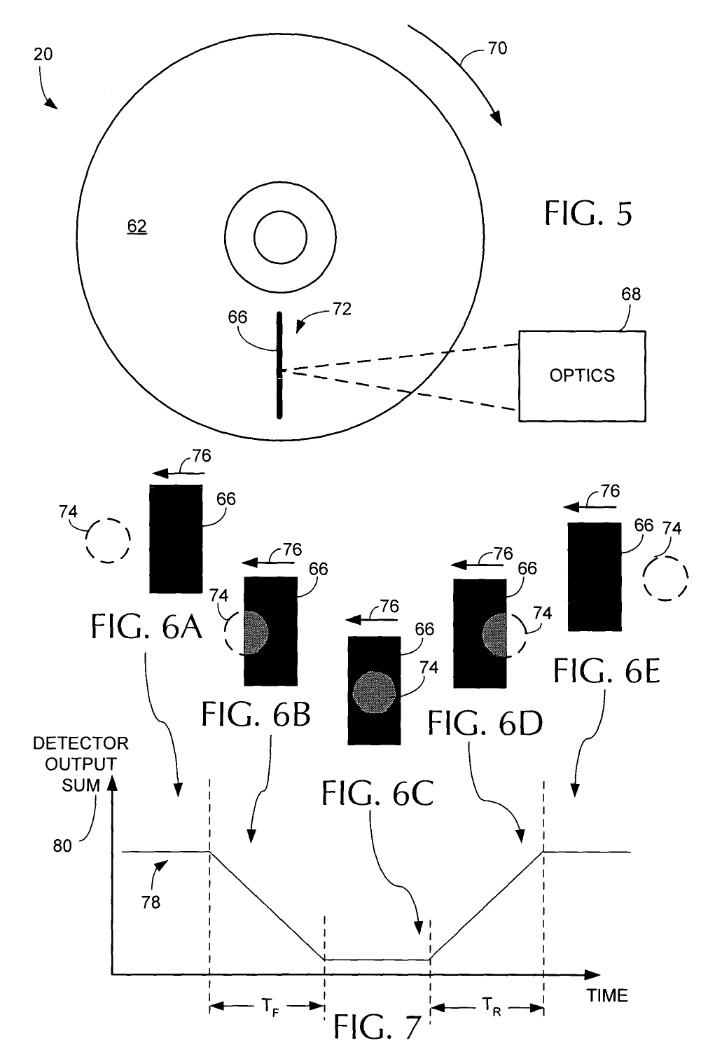

FIG. 5 schematically illustrates one embodiment of a storage media 20 having one embodiment of a feature of reflectivity change 66. The feature of reflectivity change 66 is constructed as part of the storage media 20 such that it is visible to the optics system 68 from the label side 62 of the storage media 20. The feature of reflectivity change 66 illustrated in FIG. 5 is a non-reflective bar which will be visible to the optics system 68 as the storage media 20 rotates 70. The schematic illustration of FIG. 5, like the other schematic illustrations in this disclosure, is not drawn to scale. The feature of reflectivity change 66 may extend over a small portion of the storage media 20, or over a large portion of the storage media 20. In other embodiments, the feature of reflectivity change 66 may take on other patterns, such as several stripes, blocks, or even a checkerboard type of pattern. The feature of reflectivity change 66 may be non-reflective, partially reflective, or more reflective as compared to the surrounding areas which are made of a different reflectivity. The feature of known reflectivity change may include at least one transition from a lower reflectivity to a higher reflectivity, or visa-versa. The feature of reflectivity change 66 may be present in the label layer 30 of the storage media 20, the data layer 26, or both, provided the optics system 68 can sense the desired feature of reflectivity change 66.

A storage media 20 having a feature of reflectivity change 66 can be read, written-to, or imaged from the label side 62, despite the lack of a suitable astigmatic focus error signal 60, such as the one illustrated in FIG. 2. FIGS. 6A-6E schematically illustrate embodiments of a feature of reflectivity change 66 on a storage media 20 passing nearby, under, and past a light source spot 74. In FIG. 6A, the feature of reflectivity change 66 is approaching the light source spot 74. The direction of the feature of reflectivity change 66 movement relative to the spot 74 is illustrated as direction 76. At this point, the light source spot 74 is over a reflective region, so the light will be reflected back to the photo sensor 48. In FIG. 6B, the feature of reflectivity change 66 has partially passed under the light source spot 74. At this point, the light falling onto the feature of reflectivity change 66 will not be reflected back to the photo sensor 48 as strongly as the light not falling on the feature of reflectivity change 66. As more of the light source spot 74 falls onto the feature of reflectivity change 66, the amount of light incident on the photo sensor 48 will decrease until the light source spot 74 is completely over the feature of reflectivity change 66, as illustrated in FIG. 6C. At this point, in this embodiment, the light reflected back to the photo sensor 48 will be at a minimum. In FIG. 6D, the feature of reflectivity change 66 has partially passed by the light source spot 74. As more of the feature of reflectivity change 66 passes by the light source spot 74, the amount of light reaching the photo sensor 48 will increase until the feature of reflectivity change 66 has completely passed by the light source spot 74 as illustrated in FIG. 6E.

FIG. 7 illustrates one embodiment of a reflectivity step function 78, which could result when passing a feature of reflectivity change 66 under a light source spot 74 as was described for FIGS. 6A-6E. While the photo sensor 48 is typically segmented into multiple regions to enable astigmatic focus error detection, the outputs of those regions may be summed to provide a detector output sum 80. This detector output sum 80 may also be referred to as a central aperture signal. As FIG. 7 illustrates, the detector output sum 80 will fall during a fall time T_{F} as the feature of reflectivity change 66 passes under the light source spot 74. The detector output sum 80 will then rise during a rise time T_{R} as the feature of reflectivity change starts to pass by the light source spot 74. The rise time T_{R} and the fall time T_{F} are proportional to the light source spot size. If the spot size is small, then the rise/fall time will be small. Conversely, if the spot size is larger, then the rise/fall time will be larger. While the embodiments described herein may refer to the storage media 20 (and therefore the feature of reflectivity change 66) passing by the light source spot 74, it should be understood that the concepts described herein and their equivalents may also be applied to systems where the light source spot 74 is moving, or systems where both the light source spot 74 and the storage media 20 are moving.

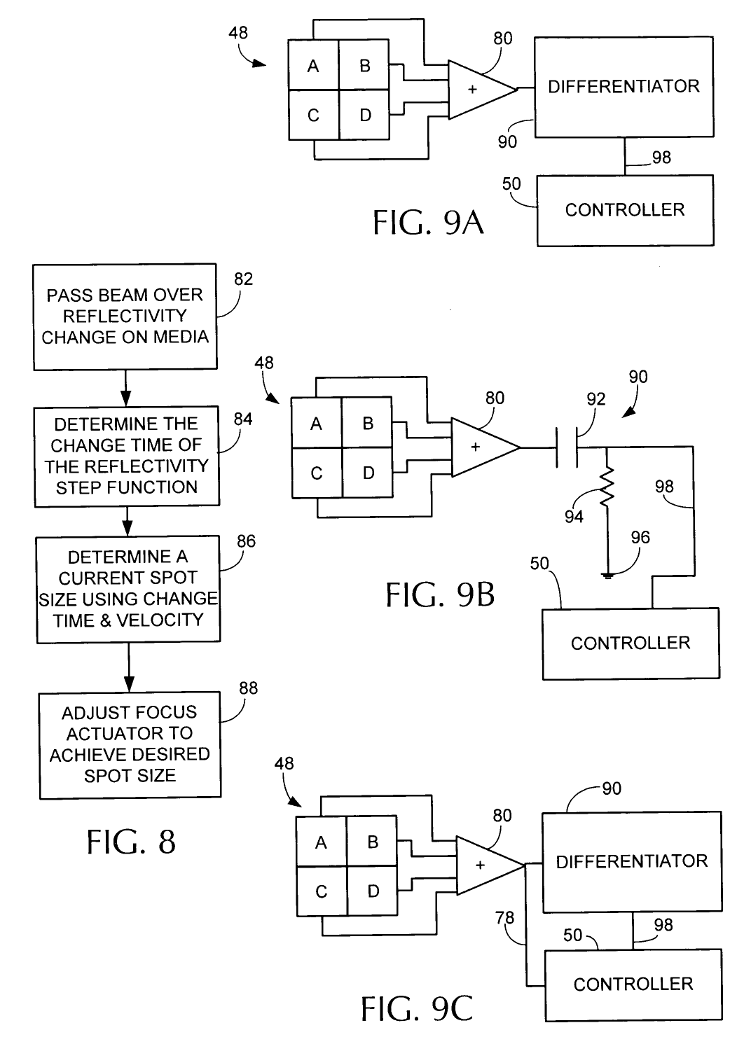

FIG. 8 illustrates one embodiment of actions which may be taken to adjust the focus of a light source on a storage media 20 by making use of the reflectivity step function 78 of FIG. 7. In a passing action 82, a light source beam is passed over a reflectivity change on the storage media. In a determining action 84, the ‘change time’ of the reflectivity step function is determined. The ‘change time’ can refer to either the rise time T_{R} or the fall time T_{F}, as discussed above with regard to FIG. 7. In another determining action 86, the light source spot size is determined using the change time and the velocity of the storage media relative to the light source beam. This size determination 86 may be accomplished by dividing the velocity of the storage media by the change time. Once the light source spot size is known, in an adjusting action 88, the focus actuator may be adjusted to achieve a desired spot diameter. The desired spot diameter may be a specific size, or it may simply be a minimized or substantially minimized spot diameter.

A controller may be suitably configured to process the reflectivity step function according to the embodiment of FIG. 8. For the purpose of servo control of the focus actuator, however, it may be desirable to provide a slope detector coupled to the detector output sum 80. FIGS. 9A-9C schematically illustrate embodiments of a slope detector for focus error signal generation.

One possible slope detector is the differentiator 90 of FIG. 9A. The photo sensor 48 output sum 80 is coupled to the differentiator 90 in the embodiment of FIG. 9A. The differentiator 90 may then be coupled to the controller 50. One example of a differentiator 90 is illustrated in the embodiment of FIG. 9B. A capacitor 92 is coupled in series between the photo sensor 48 output sum 80 and the controller 50. A resistor 94 is coupled between the controller 50 side of the capacitor 92 and a ground 96. Optionally, an inductance to ground could also be used in place of the resistor 94. Other differentiators 90 will be apparent to those skilled in the art and are intended to be covered by the scope of this disclosure.

The output 98 of the differentiators 90 in FIGS. 9A and 9B can be a voltage, the amplitude of which is proportional to the slope of the reflectivity step function 78. A larger amplitude would correspond to a higher slope, a shorter change time, and a smaller light source spot size. A smaller amplitude would correspond to a lower slope, a longer change time, and a larger light source spot size. Thus, the output of the differentiator could be used instead of the astigmatic focus error signal, without the need to modify existing storage media reader/writer optical paths.

FIG. 9C illustrates another embodiment of a slope detector for focus error signal generation. Like FIG. 9A, the photo sensor 48 output sum 80 is coupled to a differentiator 90. The differentiator output 98 is coupled to the controller 50. In FIG. 9C, however, the output of the reflectivity step function 78 is also coupled to the controller 50. The controller 50 may then determine the amplitude of the step change in the reflectivity step function 78, and normalize the differentiator output 98 by dividing the differentiator output 98 by the amplitude of the step change in order to minimize the sensitivity of the circuit to changes in the intensity of the light source 32. The amplitude of this normalized signal at the desired spot size would then be the zero error operation point of a control system responsible for control of the focus actuator 44. If the spot decreases in diameter, then the amplitude would increase, and a compensated correction may be fed by the controller to the focus actuator 44 to move the focusing lens 42 in a direction to enlarge the spot size. Likewise, if the spot was too large, the lower amplitude signal detected would be fed back to cause movement of the focus actuator 44 in the opposite direction.

The ability to derive a focus error signal in a storage media drive without needing to rely on quadrature astigmatic error detection enables label-side media storage reading and/or writing, as well as imaging of a light and/or heat activated color structure in the label layer without significant redesign of existing storage media drive architectures. Due to possible differences in spherical aberration which may be present when using a light source from the label side of a storage media, the data spot size which could be written to or read from the storage media may be limited when compared to the spot size available when operating a light source from the data side. The spot size available from the label side, however, could be adjusted to provide a suitable resolution for imaging a visible image on the label layer. A storage media apparatus could accept a storage media in a first orientation whereby the data side of the storage media is facing a light source for data reading and/or writing. The storage media could then be ejected and reinstalled in a second orientation whereby the label side of the storage media is facing the light source for label imaging. Some data reading and/or writing could also be done while the storage media is in this second orientation. Alternatively, a storage media apparatus could be designed with multiple light sources such that at least one light source could be focused on the data side of the storage media, while at least one other light source could be simultaneously or alternately focused on the label side of the storage media. In other alternatives, a storage media apparatus could be designed to have an optic path that allowed a single light source to be selectively focused on the label side or the data side of a storage media without the need to alter the orientation of the storage media.

A range of other benefits have been discussed above. The optical path architecture illustrated in the embodiments is not meant to be limiting, as other functionally equivalent optical paths may be envisioned. The methods described herein, and their equivalents may be practiced in an astigmatic system or a non-astigmatic system. The illustrated photo sensor of the embodiments was described as a quad-photo sensor. The methods described herein, and their equivalents may be practiced with a single-site photo sensor or any multiple-segment photo sensor. Additionally, it is apparent that a variety of other structurally and functionally equivalent modifications and substitutions may be made to implement focus error signal generation according to the concepts covered herein, depending upon the particular implementation, while still falling within the scope of the claims below.

1. A method of focus control, comprising:
passing a light source beam over a reflectivity change on a storage media;
determining a change time of a reflectivity step function; and
determining a current light source spot size using the change time and a storage media velocity.

2. The method of claim 2, further comprising:
adjusting a focus actuator to achieve a desired spot size based on the current light source spot size.

3. The method of claim 1, wherein the reflectivity step function is derived from the output of at least one photo sensor.

4. The method of claim 3, wherein the change time comprises a photo sensor output rise time.

5. The method of claim 3, wherein the change time comprises a photo sensor output fall time.

6. The method of claim 1, wherein:
passing the light source beam over the reflectivity change on the storage media comprises moving the storage media with respect to the light source beam, while holding the light source beam stationary; and
the storage media velocity is the velocity of the storage media relative to the light source beam.

7. The method of claim 1, wherein:
passing the light source beam over the reflectivity change on the storage media comprises moving the light source beam with respect to the storage media, while holding the storage media stationary; and
the storage media velocity is the velocity of the storage media relative to the light source beam.

8. The method of claim 1, wherein:
passing the light source beam over the reflectivity change on the storage media comprises moving both the storage media and the light source beam with respect to each other; and
the storage media velocity is the velocity of the storage media relative to the light source beam.

9. The method of claim 1, wherein the reflectivity change on the storage media comprises a change from a higher reflectivity to a lower reflectivity.

10. The method of claim 1, wherein the reflectivity change on the storage media comprises a change from a lower reflectivity to a higher reflectivity.

11. The method of claim 1, wherein the reflectivity change on the storage media comprises a bar in a label layer of the storage media.

12. The method of claim 1, wherein the reflectivity change on the storage media comprises a stripe in a label layer of the storage media.

13. The method of claim 1, wherein the reflectivity change on the storage media comprises a checkerboard pattern in a label layer of the storage media.

14. The method of claim 1, wherein the reflectivity change on the storage media comprises a bar in a data layer of the storage media.

15. The method of claim 1, wherein the reflectivity change on the storage media comprises a stripe in a data layer of the storage media.

16. The method of claim 1, wherein the reflectivity change on the storage media comprises a checkerboard pattern in a data layer of the storage media.

17. The method of claim 1, wherein passing the light source beam over a reflectivity change on the storage media comprises passing the light source beam from a label side of the storage media over the reflectivity change on the storage media.

18. The method of claim 1, wherein the storage media is selected from the group consisting of a compact disc and a digital versatile disc.

19. A method for focus error signal generation, comprising:
passing a light source beam over a reflectivity change on a storage media; and
determining a slope of a reflectivity step function, based on reflected light from the passing light source beam sensed by at least one photo sensor, for use as a focus error signal.

20. The method of claim 19, wherein determining the slope of the reflectivity step function comprises passing a photo sensor output through a differentiator.

21. The method of claim 19, wherein determining the slope of the reflectivity step function comprises passing a sum of multiple photo sensor outputs through a differentiator.

22. The method of claim 21, wherein the differentiator comprises a series capacitor and a resistor to ground.

23. The method of claim 19, further comprising normalizing the slope of the reflectivity step function by dividing the slope of the reflectivity step function by an amplitude of the at least one photo sensor.

24. A method of imaging a label layer on a storage media, comprising:
generating a focus error detection signal from a feature of reflectivity change on the label side of the storage media by analyzing a change time of a reflectivity step function;
adjusting a focus actuator to obtain a desired focus spot size by minimizing the focus error detection signal; and
selectively turning a light source on over areas of the label layer which are sensitive to the light source to produce a visible image on the label layer.

25. A storage media apparatus, comprising:
a focus lens;
a focus actuator coupled to the focus lens;
a light source configured to emit light through the focus lens onto a storage media;
a photo sensor configured to produce an output signal proportional to the total reflected light from the storage media; and
differentiator coupled to the photo sensor output signal.

26. The storage media apparatus of claim 25, wherein the storage media is selected from the group consisting of a compact disc and a digital versatile disc.

27. The storage media apparatus of claim 25, wherein the light source is further configured to emit light through the focus lens onto a label side of the storage media.

28. The storage media apparatus of claim 27, wherein the storage media is permanently housed in the storage media apparatus.

29. The storage media apparatus of claim 27, wherein the storage media is removeably housed in the storage media apparatus.
